(19) United States
(12) Patent Application Publication
(10) Pub. No.: US 2013/0001143 A1
(43) Pub. Date: Jan. 3, 2013

(54) SELF-FILTERING PERSONAL BOTTLE APPARATUS WITH ISOLATED FILTER

(75) Inventor: Steven D. Nelson, Buena Park, CA (US)

(73) Assignee: GOMATE LLC, Buena Park, CA (US)

(21) Appl. No.: 13/175,562

(22) Filed: Jul. 1, 2011

(51) Int. Cl. B01D 35/153; A23L 2/72

(52) U.S. Cl. 210/136

(57) ABSTRACT

Inner and outer containers, telescoped together so the outer container can receive unfiltered liquid to be forced through a filter in the inner container, the inner container including an isolation flapper to permit flow from the filter but block flow back to the filter.

### BACKGROUND OF THE INVENTION

1. Field of the Invention

The field of the invention relates to sports bottles and particularly to sports bottles incorporating filters for filtering tap water and the like.

2. Brief Description of Related Art

With the active healthy way of life subscribed to by many in society, a great demand exists for personal sports bottles for carrying a quantity of refreshing or energizing liquid for quick hydration during sporting activities such as running, bicycling, hiking, tennis, golf and the like. Typically, sports bottles are constructed of plastic, a material often not biodegradable and, with the relatively high consumption at today's rates, the landfills are fast filling with single use bottles.

It has long been recognized that the cost and inconvenience of accessing filtered water is a problem which can discourage consumption of sufficient quantities of fluids to adequately hydrate the athlete. Accordingly, there has long existed a need for a compact and convenient filtration device which would allow for use of readily available tap water to be conveniently and inexpensively introduced and filtered allowing for numerous repeated fills and a long service life.

The need for water purification was recognized long ago by inventors seeking to provide a filter which could be connected between the threaded necks of water bottles to thus allow for filtration of water through exhausted Zeolite filters for purifying and sterilization of the water. A device of this type is shown in U.S. Pat. No. 2,167,225 to Van Eweyk. These devices are relatively cumbersome and impractical, being insufficient compact for personal use to be carried from one's waste or on a bicycle frame or the like.

A common theme followed by many artisans has been the proposals of water bottles incorporating filters in the dispensing neck or the like on the theory that a user would draw water from the bottle through the filter. It has also been proposed to design the walls of the bottles to flex inwardly under manual pressure to thereby allow for reduction of volume to either drive fluid through the filter or possibly to allow for the recovery of the compressed walls to draw a partial vacuum thus drawing fluid from an unfiltered compartment through a filter or the like. As will be appreciated, neither the partial vacuum created by oral application of suction to the release valve of a sports bottle or partial vacuum applied by recovery of compressed sidewall is sufficient to create any appreciable pressure drop to force any meaningful volume of flow through a filter to remove impurities.

Efforts to improve on these prior devices have led to the proposal that a bellows pump be mounted on top of a bottle having a side straw so that fluid can be pressurized downwardly through a filter into the bottle to thus be available for withdrawal through the side straw. A device of this is shown in U.S. Pat. No. 5,733,448 to Kaura. While satisfactory for producing some filtration, such devices are incapable of taking the normal form of a traditional sports bottle and, furthermore, typically leave the filter exposed to the drinkable fluid whereby the addition of any additives to the drinking water are exposed directly to the filter thus creating a risk of clogging and contamination of the filter thereby reducing the service life.

A device incorporating a filter in the neck of a bottle for filtering as the wall of the bottle is compressed to squeeze the fluid from the bottle is shown in U.S. Pat. No. 6,468,435 to Hughes.

A multi-stage water purification device has been proposed including a lower compartment having a flexible wall which may be compressed and then released to draw a partial vacuum to thus draw unfiltered water downwardly from an overhead compartment through a multi-stage filter to be partially filtered and stored in the lower compartment so that upon subsequent compression of the flexible wall the partially filtered water will be driven upwardly through a one-way valve to pass through a second stage filter to a filtered water compartment ready to be discharged through a pull up valve. (A device of this type is shown in U.S. Pat. No. 7,585,409 to Bommi et al.) Such devices are relatively complicated, expensive to manufacture and rely on atmospheric pressure to control the rate of fluid flow through the first stage filter.

It has long been recognized that inexpensive filtration bottle devices would be beneficial. It has been proposed to construct a bottle including an outer open top receptacle for receiving a plunger with a bottom well configured of a filter whereby the inner member could be filled with water and plunged into the outer receptacle and then drawn therefrom to create a partial vacuum under the filter causing the water to be drawn to the filter for storage in the outer receptacle to be drawn therefrom on demand. A device of this type is shown in U.S. Pat. No. 1,386,340 to Wüster. Such devices are impractical for personal water bottles and suffer the shortcoming that the filter is exposed directly to the water so as to result in contamination or clogging by any supplements or mixtures that might be mixed with the water.

Examples of other efforts to create potable water by removing particulates and pathogens from the water include a container constructed to receive a plunger device configured so that when the plunger is plunged into the container water will be forced through a filter device for collection and storage for subsequent usage. A device of this type is shown in U.S. Pat. No. 5,268,093 to Hembree. While beneficial for purification of water on a large scale, such devices are totally impractical for personal use in a sports bottle, and, again, expose the filter directly to any mixtures or supplements that might be incorporated in the water itself.

Other efforts at solving the filtered water problem have led to the proposal of a plunger configured with a filter media defining a platen to be plunged into a container of water to purportedly filter the water through the platen. A device of this type is shown in U.S. Pat. No. 7,854,848 to Olson. Such devices have proven impractical and, again, expose the filter directly to any supplements or mixtures which might be included in the water.

Until now artisans were faced with the dilemma of selecting between relatively cumbersome self-filtering sports bottles that were inconvenient to use and those to which the use was discouraged from adding additives because of filter clogging problems.

It will be appreciated that the significant demand for inexpensive and conveniently available filtered water has led to various proposals for portable filtration bottles. The shortcoming of many such bottles is that the flexibility of the users in adding supplements, flavorings and enhancements to water or the like is restricted due to the fact that the supplements will typically come into contact with the filter media, thus clogging the filter medium and significantly reducing the service life, thereby making the self-filtering potable bottles impractical. It is this shortcoming to which the present invention is directed.

### SUMMARY OF THE INVENTION

Briefly and in general terms, the present invention is directed to a two piece personal self-filtering bottle apparatus with filter isolated from the filtered water cup.

The features and advantages of the invention will be more readily understood from the following detailed description which should be read in conjunction with the accompanying drawings.

### BRIEF DESCRIPTION OF THE DRAWINGS

FIG. 1 is a perspective view of a self-filtering portable bottle apparatus of the present invention;

FIG. 2 is a partial perspective view showing the filter apparatus of the present invention;

FIG. 3 is an exploded view of the plunger apparatus incorporated in the filtering apparatus of the present invention;

FIG. 4 is a vertical sectional view, in a large scale, taken along the line 4-4 of FIG. 1 but showing the plunger device received within the cup;

FIGS. 5, 6 and 7 are respective transverse sectional views taken along the respective lines 5-5, 6-6, and 7-7 of FIG. 4;

FIG. 8 is a detailed sectional view, in enlarged scale, of an upper portion of the apparatus shown in FIG. 4;

FIG. 9 is a transverse sectional view, in reduced scale, of the cup shown in FIG. 4 filled with liquid;

FIG. 10 is a vertical sectional view similar to FIG. 9 but showing the plunger being received in the cup;

FIG. 11 is a vertical sectional view of the apparatus shown in FIG. 7, but in enlarged scale and showing the operation of a vent valve.

FIG. 12 is a vertical sectional view, in enlarged scale, taken along the line 12-12 of FIG. 10;

FIG. 13 is a partial perspective view, in reduced scale, of the apparatus shown in FIG. 2, but with a cap mounted thereon; and

FIG. 14 is a transverse sectional view, in enlarged scale, taken along the line 14-14 of FIG. 13.

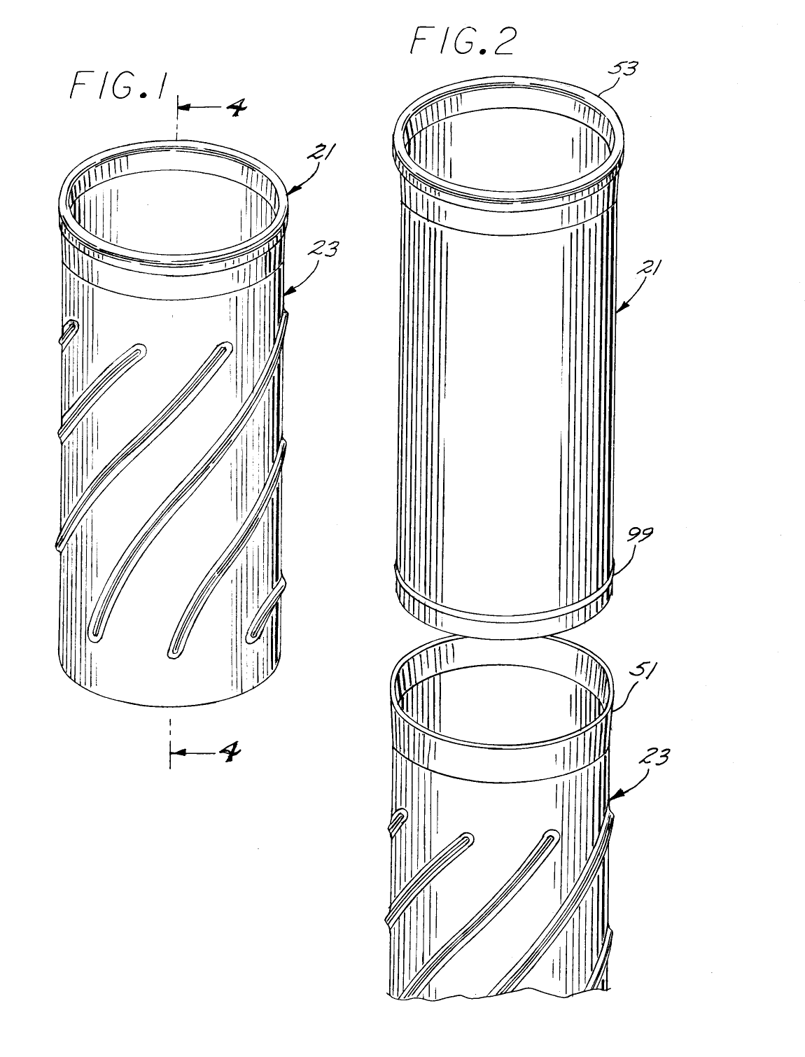

### DETAILED DESCRIPTION OF THE PREFERRED EMBODIMENTS

Referring now in more detail to the exemplary drawings for purposes of illustrating embodiments of the invention, wherein like reference numerals designate corresponding or like elements among the several views,

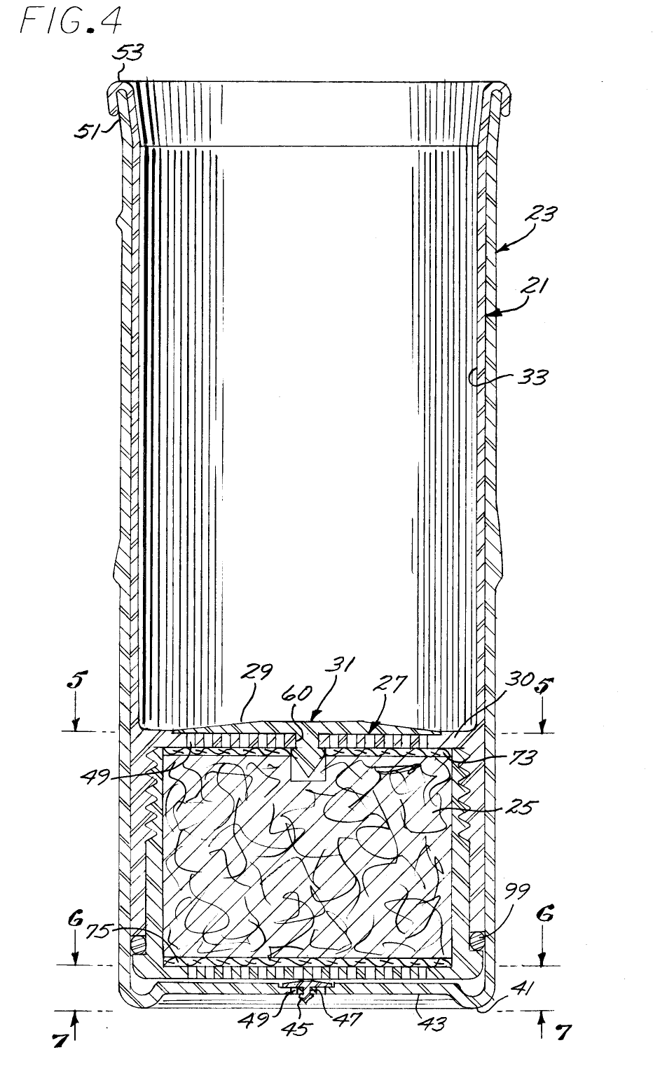

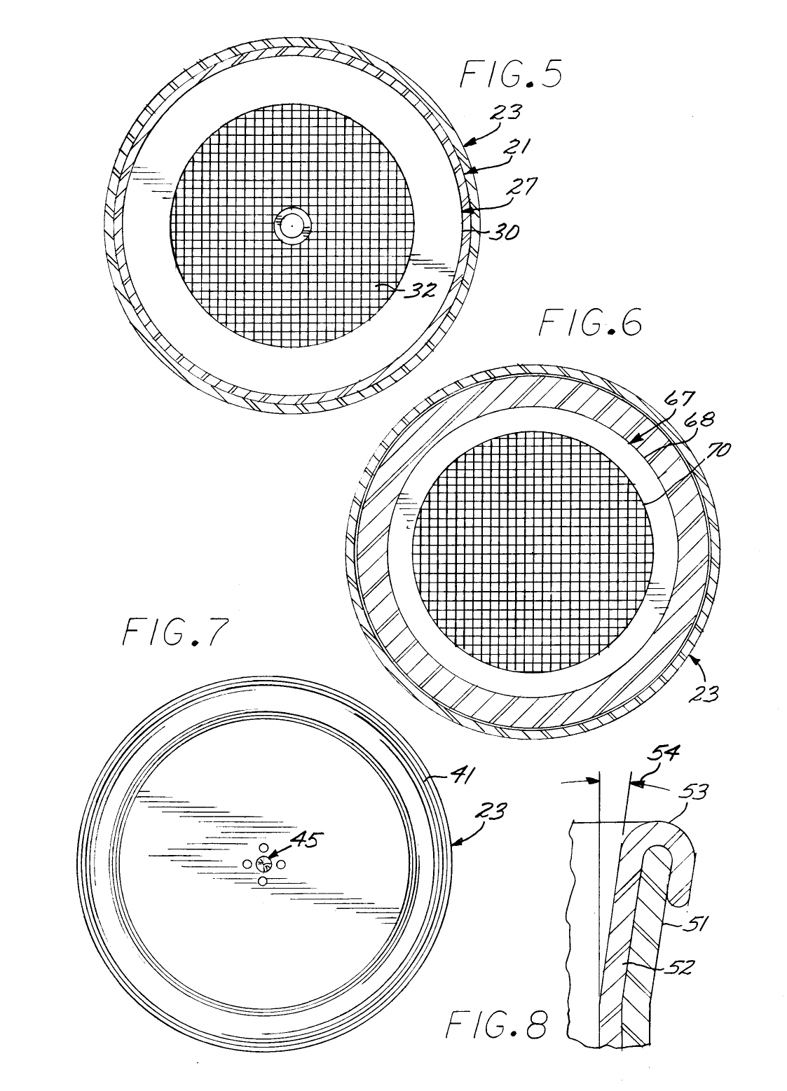

Referring first to FIGS. 2 and 4, the personal water filtration cup apparatus of the present invention includes, generally, a pair of inner and outer containers 21 and 23 forming, respectively, a cup device and a fluid receptacle 21 and 23. The cup device 21 includes in its lower extremity a through filter device, generally designated 25, for flow of liquid upwardly through a grill 27 to lift a flapper 29 of an isolation device, generally designated 31, off the grill for flow of liquid into the upper cup 33 to provide filtered water. When pressurization of the filter device is diminished, the flapper 31 will lay down over the grill 27 as shown in FIG. 31 to prevent backflow of liquid into the filter device.

The receptacle 23 is conveniently constructed of readily available plastic material and is formed in its lower portion with a peripheral rib 41 (FIG. 4) to elevate the bottom wall 43 slightly. The bottom wall 43 is formed with a through-port 45 which receives the stem 47 of a poppet valve, generally designated 49, that serves to vent air into the receptacle when the plunger-type cup apparatus is elevated.

The upper portion of the receptacle 23 is formed with an upwardly and readily outwardly tapered flange 52 configured for convenient receipt of a turnback engagement flange 53 formed in the upper extremity of the cup apparatus.

The cup apparatus 21 is configured in its lower portion with an integral transverse wall defining the grill 27 (FIG. 12) to form a plurality of through-ports 49 arrayed thereabout and covering the majority of the transverse cross-section of the cup 33 to thereby provide for a high-volume combined flow area to provide minimal resistance to flow of fluid. The grill 27 may take numerous different forms, and in the preferred embodiment provides a combined flow area of at least 50% of the overall cross-sectional area of the cup and preferably approximately 60% of the overall flow area to thereby provide for the desired structural integrity while still minimizing the resistance to fluid flow upon pressurization of the filter device.

With continued reference to FIG. 12, the grill 27 is spaced a distance upwardly about one-fifth the length of the overall cup apparatus from the bottom end 51 thereof, and is formed in its upper extremity with coarse internal female threads 53.

An upwardly opening filter cup, generally designated 57, is received in the lower extremity of the cup apparatus and is formed with a cylindrical wall configured in its upper extremity with male threads 61 for meeting with the lower extremity of the filter cup is configured with a radially outwardly projecting rib 65 to complement a fit within a cross section of the receptacle.

The filter cup 57 is formed with a lower wall defining a grill generally designated 67. Also configured throughout the majority of its transverse area with a plurality of flow ports 69 which provide a combined flow area in excess of 25% of the overall transverse cross section of the cup apparatus and in the preferred embodiment provide a combined cross-sectional flow in excess of 50% of the overall transverse cross-section of the cup apparatus.

The grill 27 is formed centrally with an enlarged bore 60 which receives a downwardly projecting compressible stem 62 of the isolation device 31. The stem 62 is formed on its lower extremity within an enlarged cross-section stop 64 to cooperate in securing the isolation device to the grill.

The filter apparatus includes a cylindrical filter 71 which may be constructed of any desirable commercially available filter media for filtration of water such as conventional charcoal filter.

The filter 71 is sandwiched between a pair of felt retainer disks 73 and 75 to provide for containment against any possibly dislodged particles, but to allow for free flow of fluid as introduced from the lower grill 67 and to pass through the upper grill 27.

The interior wall of the cup above the grill 27 is preferably formed with a cylindrical peripheral retainer rib 40 configured to cooperate with the peripheral edge of the flapper to provide for protection of the thin peripheral edges thereof. The flapper itself is in the form of a circular plate and is configured to taper radially outwardly from a thick central section to a thin peripheral edges to thereby, in the manner dictated by well-known plate stress formulas, provide for a memory tending to maintain the flexible flapper 29 by its downwardly into contacting relationship over the pores 49 of the grill 27 to provide for sealing engagement therewith, but, to, upon application of pressure from the filter chamber on the order of 15 psi or so, provide for bending of the flapper to allow the peripheral edges to be raised for high volume flow therepast to provide for rapid flow of the newly filtered liquid. The isolation device is selected and configured to provide for effective sealing thereof as described above while providing for ready flexing under upward acting pressure to thereby provide for efficient flow. As will be appreciated by those skilled in the art, the flapper is to be constructed of material which is relatively tough and resistant to high temperatures on the order of 450 degrees Fahrenheit and more, as would be consistent with washing in a dishwasher or the like and to yet provide for the operation dictated by the disciplines of the present invention. A material found successful for this operation is floor silicone material, but may be one of several food-safe elastomeric materials known to those skilled in the art.

It will be appreciated by those skilled in the art the outer receptacle and cup apparatus may be molded of PC material and the filter cup 57 of an ABS or ABS blend material. In manufacture, these components may be molded separately and available for ready assembly.

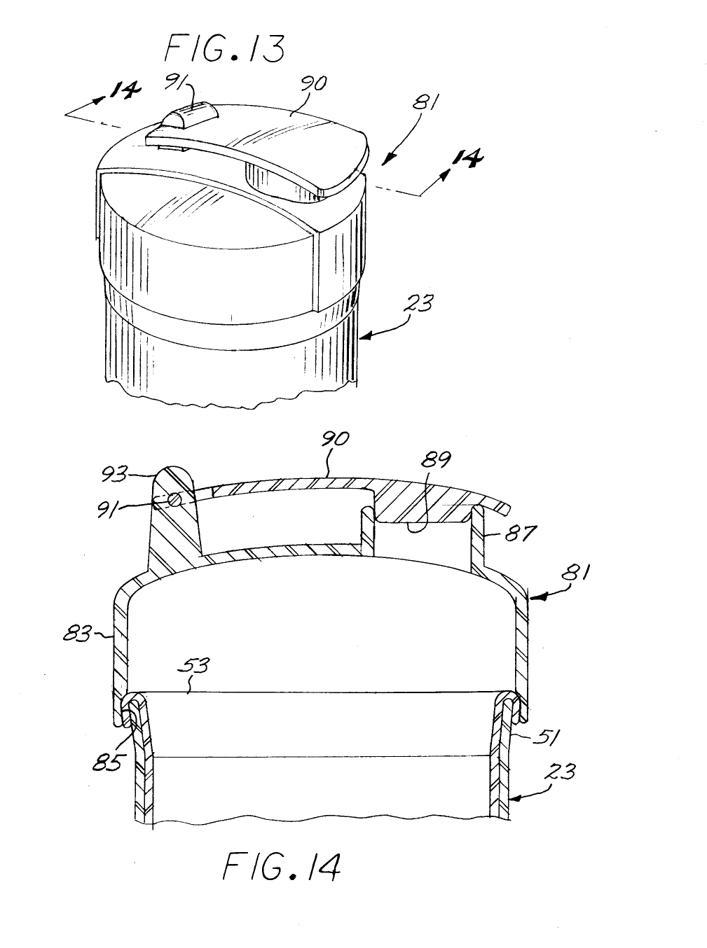

In one preferred embodiment, a pouring closure in the form of a cap device, generally designed 81 (FIGS. 13-14) may be provided for snap fit onto the personal filter body assembly of the present invention as shown in FIG. 14. The cap device 81 is formed with a domed closure 83 configured in its lower peripheral wall with a gland 85 configured to be friction-fit over the exterior of the lip to set on the top of the combined apparatus. The cap assembly 83 may be constructed of, for instance, ABS, and will be formed with an upwardly open stub drinking tube 87 covered by a friction fit plug 89 carried from a strap 90 hinged at a pivot pin 91 of an upstanding stem 93 for convenient opening and closure of the tube 87.

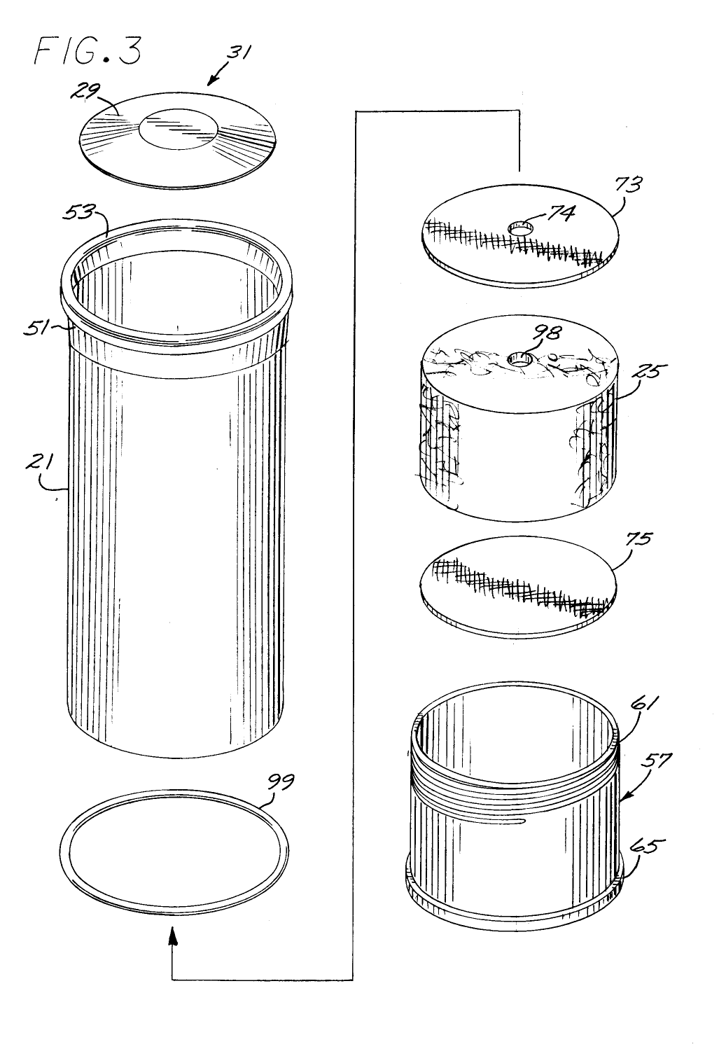

In manufacture, it will be appreciated that there are a minimum number of assembly steps. As an example, referring FIG. 3, the disk 75 may be nested down into the filter cup 57 overlying the grill 67, the filter stacked up thereon and the disk 73 placed thereover, and the combination then fitted up into the bottom end of the cup apparatus and the filter cup 57 rotated to engage the respective threads 61 and 53 to tighten the assembly in position to slightly compress the filter media to maintain a slight pressure thereon and maintain some force on the engaged threads to facilitate closure of the filter cup into the cup apparatus.

An O-ring 99 will be fitted down over the filter cup 57 to nest on the peripheral rib 65.

The umbrella isolation device 31 may be then introduced to the cup assembly from the top end thereof and the stem 62 inserted through the bore 60 to drive the conical holer 64 downwardly through such bore to compress the sides thereof, and, upon clearing the lower edge of the lower surface of the grill 27, expand and maintain the isolation device in place. It will be appreciated that a relief bore 98 is formed in a center top of the filter to provide clearance for the fastener 64.

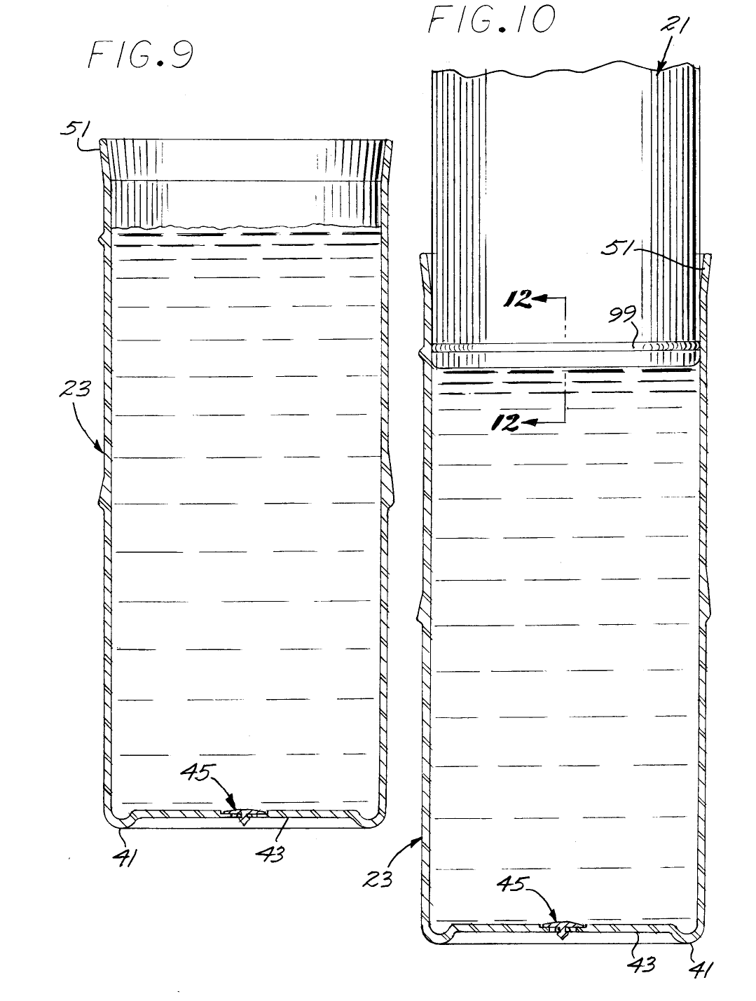

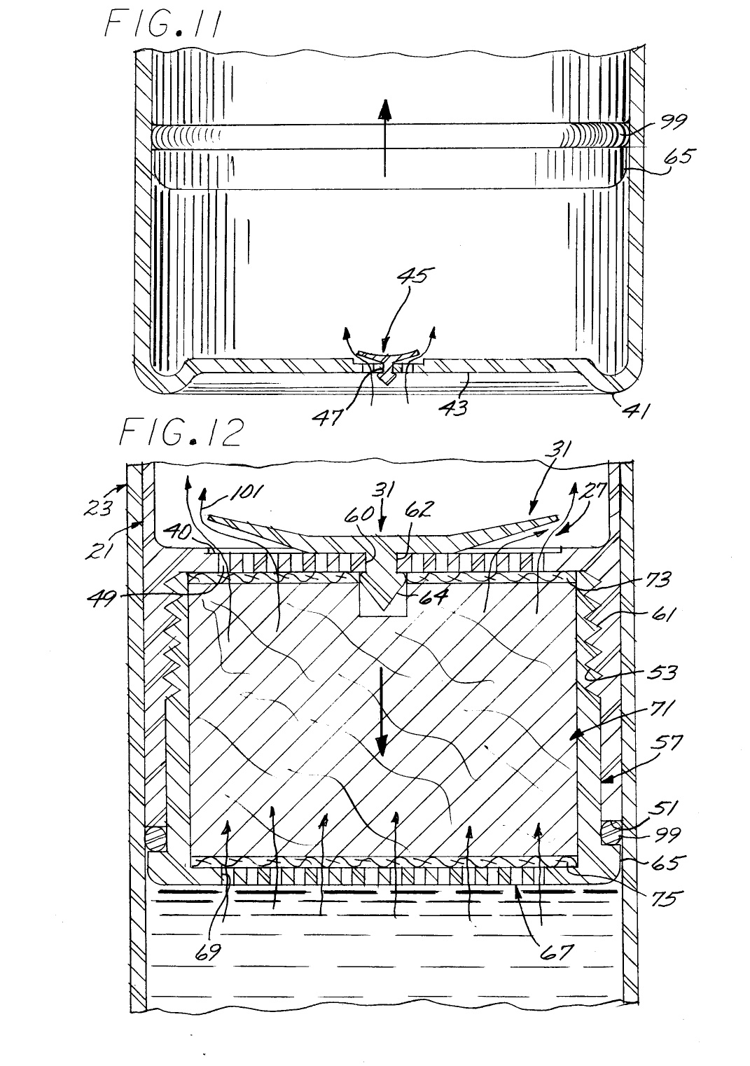

It will be appreciated that the diameter of the cup apparatus is of a size sufficiently smaller than the inside diameter of the receptacle such that the cup apparatus will telescope efficiently into the receptacle without binding, it being further appreciated that the O-ring 99 will provide a dynamic seal with the wall thereof. Thus, the components may be easily separated and the receptacle 23 filled with, for instance, tap water, and the cup apparatus 21 introduced thereinto as guided by the flare of the bell section so as to slide conveniently downwardly in plunger fashion to contact the lower extremity thereof with the water in the receptacle as shown in FIGS. 9 and 10. As the cup apparatus is plunged downwardly, the O-ring will prevent escape therepast of water. Thus, as the apparatus is forced downwardly, causing the water to flow upwardly through the opening 69 in the grill 67 and into and through the filter device 71 to flow upwardly through the top felt discs 73 and through the ports 49 to apply a pressure underneath the reduced in thickness peripheral portions of the flap 29, thereby applying a bending force to the diametrically outer portions thereof to thus bend the flapper and raise the edges thereof a shown in FIG. 12 to permit a high volume flow of water as depicted by the directional arrows 101 upwardly into the cup 33. As the full volume of water is passed upwardly through the filter device 71, as for instance 16 ounces thereof, while the cup device is pressed downwardly through its full stroke, the cup 33 will be filled with filtered water ready for consumption. As the end of the downward stroke is reached, the other portion of the lip 51 will flex and snap over the upper edge of the bell section 51 to draw the cup apparatus into place within the receptacle for a secure joinder.

The filtered water is then available for ready consumption, and, if desirable, the cap 81 (FIGS. 13 and 14) may be snapped down into place over the lip 53 to close the top of the cup portion while making the filtered water available for consumption by merely lifting the lever 91 to unplug the stub tube 87 for ready access to the water.

In the meantime, it will be appreciated that when the pressure in the filter chamber has been reduced, the memory of the material in the flapper will cause it to return to its horizontal position shown in FIG. 4 to be disposed in overlying sealing relationship over the ports 49 to thus act somewhat as a check valve to prevent flow of water back downwardly and to the filter compartment. Thus, in those many instances where users add energy or flavoring substances to the filtered water, the filter will be isolated from those substances to thus prevent contamination and clogging of the filter and protect the long life thereof.

If desirable, the cup apparatus may be removed from the exterior receptacle and will be available for transporting the filtered water about as desired by the user.

It should also be noted that, when the cup apparatus is retained in the receptacle 23 as shown in FIG. 4, once the filtered water has been consumed, the cup assembly 21 may be rapidly withdrawn by the user grasping the overhang of the rib 53 to draw it vertically upwardly as the wall of the cup defining the bell mouth 51 is flexed inwardly to allow for release, thereby freeing the cup assembly to be lifted relative to the receptacle. It will be appreciated that this action will cause a partial vacuum to be generated beneath the lower grill 67, thereby applying a pressure differential across the poppet valve 49, causing such poppet valve to be raised off its seat for introduction of atmospheric air to thereby break the partial vacuum and free the cup assembly to be drawn quickly and rapidly upwardly to be removed from the receptacle for refill of the receptacle itself.

When the apparatus is emptied and it is desired to wash the cup apparatus, it can be placed directly in an automatic dishwasher or the like and tests have proven that the isolation device, filter and components will accommodate the heat and environment of such a dishwasher and will be available for subsequent.

From the foregoing it will be appreciated that the self-filtering portable bottle apparatus of the present is economical to manufacture, efficient to use and offers the flexibility of allowing the user to supplement his or her drink with additives and supplements without concern for clogging the filter to thereby provide for a long and trouble free life.

The invention may be embodied in other forms without departure from the spirit and essential characteristics thereof. The embodiments described therefore are to be considered in all respects as illustrative and not restrictive. Although the present invention has been described in terms of certain preferred embodiments, other embodiments that are apparent to those of ordinary skill in the art are also within the scope of the invention. Accordingly, the scope of the invention is intended to be defined only by reference to the appended claims.

We claim:

1. A self filtering personal beverage cup apparatus comprising:
separable upright inner and outer containers formed with respective inner and outer peripheral walls and bottom walls and constructed for sliding receipt of the inner container within the outer container, the inner container defining a cup and the outer container a holder;
top and bottom filter grill dividers in the lower portion of the inner container and cooperating with the inner container peripheral wall to form a filter compartment and configured to leave a liquid storage compartment there above;
a one way isolation device overlaying the upper divider to flow liquid from the filter compartment to the storage compartment and further configured to block flow from the storage compartment to the filter compartment;
a filter in the filter compartment for filtering liquid flowing from the inlet to the one way valve; and
a dynamic liquid seal interposed between he inner and outer containers whereby the inner container may separated from the outer container, liquid placed in the outer container and the inner container inserted therein and pressed downwardly in sliding relationship there into to force the liquid in the inlet, thought the filter and through the one way valve into the upper storage compartment to be stored for consumption.

2. The self filtering personal cup apparatus of claim 1 wherein:
the upper is in the form of a grill spanning substantially the entire transverse cross section of the inner container.

3. The self filtering personal cup apparatus of claim 1 wherein:
the isolation device is in the form of an umbrella valve.

4. The self filtering personal cup apparatus of claim 3 wherein:
the poppet valve includes a cap sized to compliment the transverse cross section of the inner container.

5. The self-filtering personal cup apparatus of claim 1 that includes:
an O-ring gland in the outer surface of the inner container; and
the dynamic liquid seal is received in the gland.

6. The self-filtering personal cup apparatus of claim 1 wherein:
the lower portion of the inner container is formed interiorly with female threads and that includes;
a filter cup formed with a barrel having male threads for engagement with the female threads, the filter cup being configured to be received in the lower extremity of the inner container and configured to receive the filter therein.

7. The self-filtering personal cup apparatus of claim 1 wherein:
the isolation device includes a flexible flapper plate constructed to taper distally outwardly to form a progressively narrow cross section to enhance the flexibility thereof for the distal periphery.

8. The self-filtering personal cup apparatus of claim 1 wherein:
the containers are constructed with the peripheral walls being flexible and the upper extremities thereof are formed with complementally shaped, laterally outwardly and upwardly angled sections defining respective bell sections to complementary abut against one another.

9. The self-filtering personal cup apparatus of claim 8 wherein:
the inner container is configured in separate extremity with an outturned and downwardly extending flange for, upon being plunged downwardly into the receptacle, engaging over the upper edge of the outer container.

10. The self-filtering personal cup apparatus of claim 1 that includes:
a cap apparatus configured with a downwardly projecting peripheral skirt formed on its interior with a cutback groove for frictional fit on the upper extremity of the cup apparatus, the cover apparatus including a stub tube outlet.

11. The self-filtering personal cup apparatus of claim 7 wherein:
the grill is formed in its upper surface with a recess for receiving the flapper plate.

12. A self filtering personal cup apparatus comprising:
an open top upright receptacle for receipt of unfiltered liquid;
a cup device for complimentary receipt in the receptacle and including and divided into a filter device in its lower portion for flow of liquid upwardly there through and a cup in its upper portion;
an isolation device overlying the filter device and including a isolation flapper normally overlying the upper side of the filter device and operable in response to fluid pressure acting upwardly to lift off the filter device for free flow of fluid there from whereby the receptacle may be filled with unfiltered liquid and the cup, the cup inserted therein and pressed downwardly to pressurize the filter device force liquid up through the filter to lift the flapper off the filter device to flow filtered liquid into the cup and allow the flapper to return to covering relation over the filter device.

13. The self-filtering personal cup apparatus of claim 12 wherein:
the cup device includes toward the bottom extremity thereof a transverse wall defining a grill configured with a plurality of through passages for flow of liquid upwardly therethrough; and
wherein the flapper is constructed for normally covering the upper ends of the respective passages and being flexible and configured with a memory and further formed with a free outer periphery and formed to, upon application of a predetermined pressure to the underside of the laterally outer periphery thereof, raise upwardly off the transverse wall for flow of liquid through the passages to flow into the cup and further configured to, upon lowering of the pressure thereunder below a selected level, return to the normal position blocking flow through the passages.

14. The self-filtering personal cup apparatus of claim 12 that includes:
a dynamic seal interposed between the cup device and receptacle.

15. The self-filtering personal cup apparatus of claim 12 wherein:
the lower extremity of the cup device is configured with a filter cavity having, in the upper extremities thereof, female threads and wherein:
the filter device includes a filter cup configured to be received in such filter cavity and formed with male threads to mate with the female threads, the filter device further including a filter configured to be carried in the filter cup.

16. The self-filtering personal cup apparatus of claim 12 wherein:
the cup device includes on the upper and lower extremities of the filter, respective grills having a plurality of passages formed therein and distributed throughout, the passages having a transverse dimension of approximately two millimeters.

17. A self filtering personal beverage apparatus comprising:
an external, upwardly opening cylindrical container configured with a predetermined internal diameter and formed at its upper extremity with and upwardly and radially outwardly angled flexible wall defining a bell mouth;
cup apparatus configured with an external diameter less than the predetermined internal diameter, having a predetermined internal cross section, and configured in its lower extremity with an integral, transversely projecting wall formed with a plurality of vertical passages, arrayed about the internal cross section, terminating in upper extremities and configured with respective transverse flow areas on the order of two millimeters on a side and cooperating to form an upper grill, the grill being configured centrally with a stem-receiving bore;
an isolation device configured with a flexible flapper constructed to, in its relaxed position, be disposed in covering relationship over the upper extremities of the respective passages and configured centrally with a stem to be projected to the bore, the stem being formed on its lower extremity with an enlarged in cross-section, compressible, fastener having a relaxed cross-section greater than that of the bore, and being compressible so as to be capable of being pressed through the bore;
the cup apparatus further formed in its lower extremity, below the first grill with a filter chamber configured in its peripheral wall with female threads;
a filter cup configured with a barrel to be received in the filter chamber and formed with male threads to engage the female threads;
a filter received in the cup and having upper an lower surfaces;
felt barrier discs disposed on the upper and lower surfaces of the filter;
the peripheral wall of the cup apparatus being configured at its upper extremity with radially outwardly and upwardly angled funnel shaped ring to complement the bell and configured at its upper extremity with a radially outwardly turned and outwardly extending lip configured to, when the cup apparatus is plunged downwardly into the receptacle, engage over the upper edge of the bell.
